(19) United States
(12) Patent Application Publication
(10) Pub. No.: US 2011/0069072 A1
(43) Pub. Date: Mar. 24, 2011

(54) Apparatus and Method for Visualizing Data with Symmetric Total Values, First Values and Second Values

(76) Inventor: Hozumi Nakano, La Cross, WI (US)

(21) Appl. No.: 12/562,844

(22) Filed: Sep. 18, 2009

(51) Int. Cl. G06T 11/20

(52) U.S. Cl. 345/440.2

(57) ABSTRACT

A computer readable storage medium includes executable instructions to accept data. A criterion associated with the data is identified. A total value comprised of the sum of first values and second values is specified. A first indicator of the total value relative to the first values is displayed. A second indicator of the total value relative to the second values is also displayed. The first indicator is separate from and in a symmetrical relationship with the second indicator.

### FIELD OF THE INVENTION

This invention relates generally to the visualization of stored digital data. More particularly, this invention relates to a technique for visualizing data with symmetric total values, first values and second values.

### BACKGROUND OF THE INVENTION

Various techniques are used to visualize stored digital data. FIG. 1 illustrates one prior art technique in which stacked or sub-divided bars are used to visualize data. Records are displayed in accordance with a criterion. In this case, the criterion is a time dimension in the form of quarters with members first, second and third quarters (i.e., Q1, Q2 and Q3). In the case of the third quarter (i.e., Q3), a first sub-bar 100 represents a first value and a second sub-bar 102 represents a second value. For example, the first value may be validated records, while the second value may be non-validated records.

Observe that the first sub-bar 100 and the second sub-bar 102 have a common axis, but do not share a common origin. Therefore, it may be difficult to evaluate each sub-bar, particularly the second sub-bar 102 since its origin is a non-zero value. Also note that a total value may be inferred from the first sub-bar and the second sub-bar, but the total value is not clearly depicted with respect to its component parts (i.e., the first sub-bar and the second sub-bar).

In view of the foregoing, it would be desirable to provide an improved visualization technique to represent a total value and component values.

### SUMMARY OF THE INVENTION

A computer readable storage medium includes executable instructions to accept data. A criterion associated with the data is identified. A total value comprised of the sum of first values and second values is specified. A first indicator of the total value relative to the first values is displayed. A second indicator of the total value relative to the second values is also displayed. The first indicator is separate from and in a symmetrical relationship with the second indicator.

### BRIEF DESCRIPTION OF THE FIGURES

The invention is more fully appreciated in connection with the following detailed description taken in conjunction with the accompanying drawings, in which:

FIG. 1 illustrates a stacked bar graph data visualization technique of the prior art.

FIG. 2 illustrates a computer configured in accordance with an embodiment of the invention.

FIG. 3 illustrates vertically aligned and opposite projecting visualized data with symmetric total values, first values and second values.

FIG. 4 illustrates horizontally aligned and opposite projecting visualized data with symmetrical total values, first values and second values.

FIG. 5 illustrates vertically aligned and common projecting visualized data with symmetric total values, first values and second values.

Like reference numerals refer to corresponding parts throughout the several views of the drawings.

### DETAILED DESCRIPTION OF THE INVENTION

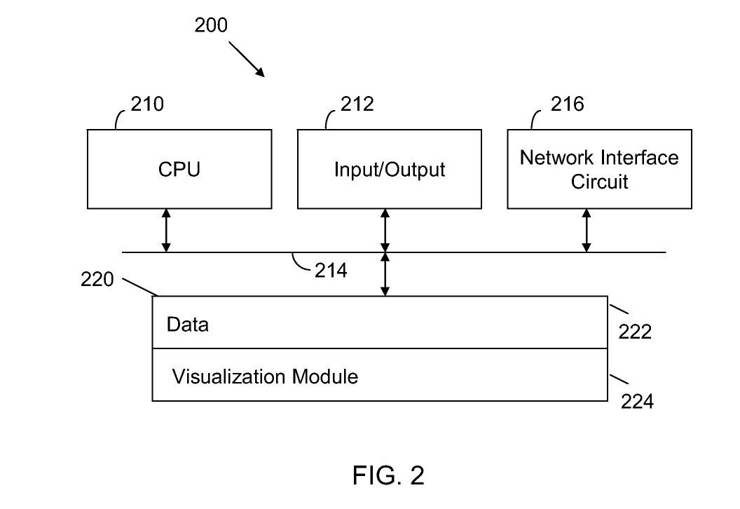

FIG. 2 illustrates a computer 200 configured to implement operations of the invention. The computer 200 includes standard components, such as a central processing unit 210 connected to a set of input/output devices 212 via a bus 214. The input/output devices 212 may include a keyboard, mouse, display, printer and the like. A network interface circuit 216 is also connected to the bus 214 to provide connectivity to a network (not shown). Therefore, the computer 200 may operate in a client/server or other networked environment.

A memory 220 is also connected to the bus 214. The memory stores data 222, which is visualized in accordance with embodiments of the invention. In particular, a visualization module 224 includes executable instructions to process the data 222 to produce visualizations of the data that include symmetric total values, first values and second values.

The visualization module 224 includes executable instructions to accept data and identify a criterion associated with the data. The criterion may be a dimension of data, such as a time dimension.

The visualization module 224 also includes executable instructions to specify a total value comprised of the sum of first values and second values. First values may be considered inclusive values that are processed and validated records for the criterion. Consider the case where the data that is accepted includes a criterion of time, a total number of customers and a number of inclusive or validated records, as shown in the following table.

TABLE I

| Criterion | New Customers | First Values |
|---|---|---|
| (Time) | (Total) | (Validated) |
| Q1 | 100 | 80 |
| Q2 | 80 | 60 |
| Q3 | 60 | 40 |

In this example, the visualization module computes second values, which may be exclusive values or non-validated values, which are the total values minus the first values, which results in the following table:

TABLE II

| Criterion | New Customers | First Values | Second Values |
|---|---|---|---|
| (Time) | (Total) | (Validated) | (Non-Validated) |
| Q1 | 100 | 80 | 20 |
| Q2 | 80 | 60 | 20 |
| Q3 | 60 | 40 | 20 |

In another example, the first values and second values are provided and the total is computed by the visualization module 224. The user or the system can associate first values and second values with different criteria, such as positive/negative, negative/positive, left/right, or right/left. Other criteria may be used to characterize the first values and the second values. In addition, embodiments of the invention may utilize the computation of additional values (e.g., third values, fourth values, etc.).

The visualization module 224 proceeds to display a first indicator reflecting the total value relative to the first values. In addition, the visualization module 224 displays a second indicator reflecting the total value relative to the second values. The first indicator is separate from and in a symmetrical relationship with the second indicator.

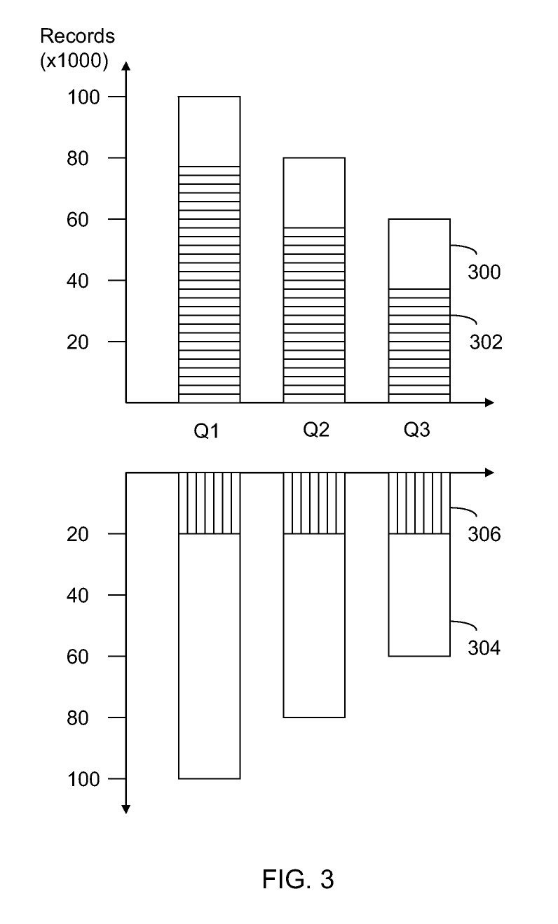

FIG. 3 illustrates a visualization of the data of Table II in accordance with an embodiment of the invention. For quarter Q3, a first indicator illustrates a total value depicted as a bar 300 with first values depicted as a sub-bar 302. A second indicator illustrates a total value depicted as a bar 304 with second values depicted as a sub-bar 306. In this example, the first indicator is symmetrical with the second indicator along a common vertical axis. More particularly, the first indicator extends in a first direction (up) along the common axis and the second indicator extends in a second direction (down) opposite the first direction along the common axis. In this way, the visualization plainly illustrates a total value with respect to the first values and the total value with respect to the second values.

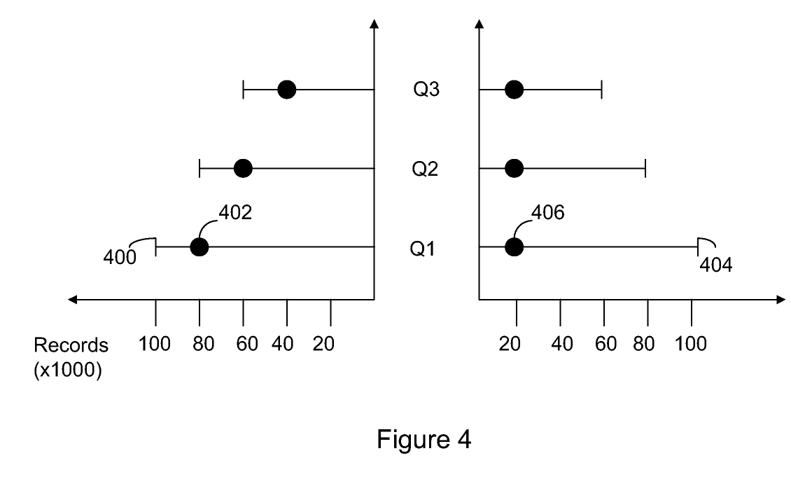

FIG. 4 illustrates an alternate visualization of the data of Table II. In this example, for quarter Q1, a first indicator illustrates a total value depicted by line 400 with first values depicted as a mark 402 positioned on the line. A second indicator illustrates the total value depicted by a line 404 with a second values depicted as a mark 406 positioned on the line. In this example, the first indicator is symmetrical with the second indicator along a common horizontal axis. More particularly, the first indicator extends in a first direction (left) along the common axis and the second indicator extends in a second direction (right) opposite the first direction along the common axis. Further, the first indicator extends the same distance as the second indicator. The distance characterizes the total value for members of the criterion. The distance is proportional to the total value for that member of the criterion.

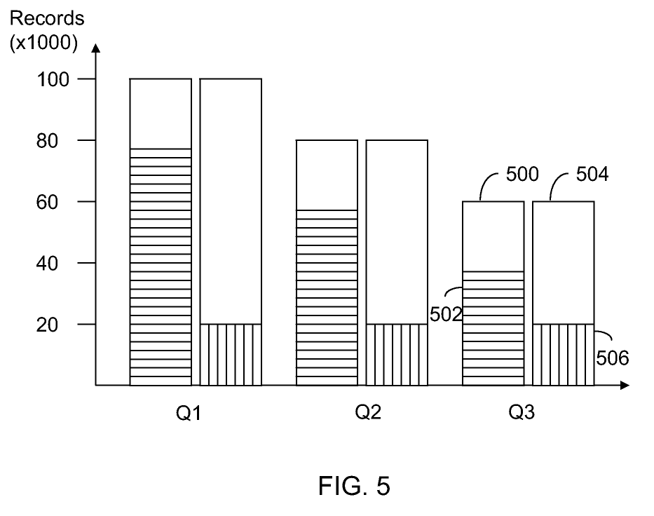

FIG. 5 illustrates an alternate visualization of the data of Table III. In this example, for quarter Q3, a first indicator illustrates a total value depicted as a bar 500 with first values depicted as a sub-bar 502. A second indicator illustrates a total value depicted as bar 504 with second values depicted as a sub-bar 506. In this example, the first indicator is symmetrical with the second indicator on opposite sides of a common vertical axis. More particularly, the first indicator extends in a first direction (up) along a common vertical axis and the second indicator extends in the same direction (up) along the opposite side of the common vertical axis. The symmetry between the first indicator and the second indicator is preserved in the visualization by having equal lengths in the same direction.

The visualization module 224 may include executable instructions to support various visualizations utilized in embodiments of the invention. For example, the visualization module 224 may include executable instructions to derive the visualization criterion from the received data. Alternately, the visualization module 224 may include executable instructions to receive a user-specified criterion for received data. As previously indicated in connection with the discussion of Tables I and II, the visualization module 224 may include executable instructions to augment the data received, for instance, by computing one of a total value, first values or second values. The visualization module 224 may also include executable instructions to accept visualization preferences from a user. The visualization preference may specify, for example, vertical alignment, horizontal alignment, bars, and lines, oppositely extending indicators or commonly extending indicators. The first direction in a visualization can be any orientation, including up, down, left, right, diagonal and the like. The visualization module 224 may also be configured with executable instructions to scale the visualization for the display or to adjust colors for display or printing.

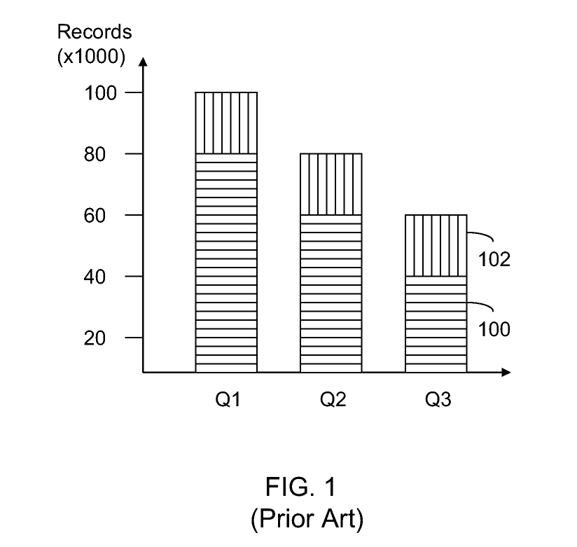

The invention provides techniques for simplifying the analysis of displayed data. In the prior art, such as shown in FIG. 1, a user may be required to compute values (e.g., exclusive values) without the benefit of a clear origin, instead having to add from a non-zero starting point (e.g., the end of a sub-bar of first values). Further, the prior art does not provide a clear indication of the total value in contrast to first values and the total value in contrast to second values, as provided with the visualizations of the invention. Advantageously, the techniques of the invention may be incorporated into a variety of tools, including data quality tools, dashboards and reporting tools.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
accept data;
identify a criterion associated with the data;
specify a total value comprised of the sum of first values and second values;
display a first indicator of the total value relative to the first values; and
display a second indicator of the total value relative to the second values, wherein the first indicator is separate from and in a symmetrical relationship with the second indicator.

2. The computer readable storage medium of claim 1 wherein the first indicator is symmetrical with the second indicator along a common axis.

3. The computer readable storage medium of claim 2 wherein the first indicator extends in a first direction along the common axis and the second indicator extends in a second direction opposite the first direction along the common axis.

4. The computer readable storage medium of claim 1 wherein the first indicator is symmetrical with the second indicator on opposite sides of a common axis.

5. The computer readable storage medium of claim 4 wherein the first indicator extends in a first direction along a first side of the common axis and the second indicator extends in the first direction along a second side of the common axis.

6. The computer readable storage medium of claim 1 wherein the first indicator is a bar representative of the total value with a sub-bar representative of the first values.

7. The computer readable storage medium of claim 1 wherein the second indicator is a bar representative of the total value with a sub-bar representative of the second values.

8. The computer readable storage medium of claim 1 wherein the first indicator is a line representative of the total value with a mark positioned on the line representative of the first values.

9. The computer readable storage medium of claim 1 wherein the second indicator is a line representative of the total value with a mark positioned on the line representative of the second values.

10. The computer readable storage medium of claim 1 wherein the first indicator and the second indicator are vertically aligned.

11. The computer readable storage medium of claim 1 wherein the first indicator and the second indicator are horizontally aligned.

12. The computer readable storage medium of claim 1 wherein the executable instructions to identify a criterion associated with the data include executable instructions to derive the criterion from the data.

13. The computer readable storage medium of claim 1 wherein the executable instructions to identify a criterion associated with the data include executable instructions to receive a user-specified criterion for the data.

14. The computer readable storage medium of claim 1 further comprising executable instructions to compute at least one of the total value, the first values and the second values.

15. The computer readable storage medium of claim 1 further comprising executable instructions to accept visualization preferences.
